(19) United States
(12) Patent Application Publication
(10) Pub. No.: US 2026/0010534 A1
(43) Pub. Date: Jan. 8, 2026

(54) DATA PARTITIONING CONDITION GENERATION APPARATUS, DATA PARTITIONING SYSTEM, DATA PARTITIONING CONDITION GENERATION METHOD, DATA PARTITIONING METHOD, AND PROGRAM

(71) Applicant: NEC Corporation, Tokyo (JP)

(72) Inventor: Shunpei SUGAWARA, Tokyo (JP)

(73) Assignee: NEC Corporation, Tokyo (JP)

(21) Appl. No.: 19/244,156

(22) Filed: Jun. 20, 2025

(30) Foreign Application Priority Data
Jul. 3, 2024 (JP) 2024-107232

(51) Int. Cl. G06F 16/2455

(52) U.S. Cl. CPC G06F 16/24554

(57) ABSTRACT

A data partitioning condition generation apparatus comprises a search condition determination part and a search part. The search condition determination part determines a search condition based on a field policy. The search part partitions data to be partitioned based on the search condition, and outputs the search condition as a partitioning condition if it is determined that a result of the partitioning satisfies limiting conditions.

### FIELD

The present invention is based upon and claims the benefit of the priority of Japanese patent application No. 2024-107232, filed on Jul. 3, 2024, the disclosure of which is incorporated herein in its entirety by reference thereto.

The present invention relates to a data partitioning condition generation apparatus, a data partitioning system, a data partitioning condition generation method, a data partitioning method, and a program.

### BACKGROUND

The following literature relates to estimation of a data-format.

PTL (Patent Literature) 1 relates to a packet-format estimation apparatus classifying a series of packets transmitted at a fixed cycle as the same packet group having the same arrival cycle among a plurality of packets whose formats are unknown and estimating a packet-format for every packet group having the same arrival cycle.
PTL 1: Japanese Patent Sai-Kohyo Application No. WO-A-2018/142620

### SUMMARY

The following analysis has been made by the present inventor.

It is necessary to partition one dimensional bit string of data to respective fields which make up the data for analyzing the data whose format is unknown. To do this, it is necessary to automatically determine a length of a field.

It is an object of the present invention to provide a data partitioning condition generation apparatus, a data partitioning system, a data partitioning condition generation method, a data partitioning method, and a program which contribute to enable to automatically determine lengths of respective fields which make up data whose format is unknown.

According to a first aspect of the present invention, there is provided a data partitioning condition generation apparatus, comprising:
a search condition determination part and a search part;
wherein the search condition determination part determines a search condition based on a field policy: and
wherein the search part
partitions data to be partitioned based on the search condition, and
outputs the search condition as a partitioning condition if it is determined that a result of the partitioning satisfies limiting conditions.

According to a second aspect of the present invention, there is provided a data partitioning system, comprising a data partitioning condition generation apparatus and a data partitioning apparatus:
wherein the data partitioning condition generation apparatus comprises a search condition determination part and a search part,
wherein the search condition determination part determines a search condition based on a field policy, and
wherein
the search part
partitions data to be partitioned based on the search condition, and outputs the search condition as a partitioning condition if it is determined that a result of the partitioning satisfies limiting conditions:
wherein the data partitioning apparatus
determines a number of the data to be partitioned which is to be read based on the partitioning condition according to the field policy,
reads the determined number of the data to be partitioned, and
outputs the partitioned data.

According to a third aspect of the present invention, there is provided a data partitioning condition generation method, wherein
a computer
determines a search condition based on a field policy,
partitions data to be partitioned based on the search condition, and
outputs the search condition as a partitioning condition if it is determined that a result of the partitioning satisfies limiting conditions. The present method is tied to a particular machine, namely, a computer which performs an above method.

According to a fourth aspect of the present invention, there is provided a data partitioning method, wherein
a computer
determines a search condition based on a field policy,
partitions data to be partitioned based on the search condition,
outputs the search condition as a partitioning condition if it is determined that a result of the partitioning satisfies limiting conditions,
determines a number of the data to be partitioned which is to be read based on the partitioning condition according to the field policy,
reads the determined number of the data to be partitioned, and
outputs the partitioned data. The present method is tied to a particular machine, namely, a computer which performs an above method.

According to a fifth aspect of the present invention, there is provided a program causing a computer to perform processings of:
determining a search condition based on a field policy,
partitioning data to be partitioned based on the search condition, and
outputting the search condition as a partitioning condition if it is determined that a result of the partitioning satisfies limiting conditions.

According to a sixth aspect of the present invention, there is provided a program causing a computer to perform processings of:
determining a search condition based on a field policy,
partitioning data to be partitioned based on the search condition,
outputting the search condition as a partitioning condition if it is determined that a result of the partitioning satisfies limiting conditions,
determining a number of the data to be partitioned which is to be read based on the partitioning condition according to the field policy,
reading the determined number of the data to be partitioned, and
outputting the partitioned data.

Note, these programs can be recorded in a computer-readable storage medium. The storage medium can be non-transitory one, such as a semiconductor memory, a hard disk, a magnetic recording medium, an optical recording medium, and so on. The present invention can be realized by a computer program product.

According to the present invention, it is possible to provide a data partitioning condition generation apparatus, a data partitioning system, a data partitioning condition generation method, a data partitioning method, and a program which contribute to enable to automatically determine lengths of respective fields which make up data whose format is unknown.

### BRIEF DESCRIPTION OF DRAWINGS

FIG. 1 is a block diagram illustrating an example of a configuration of a data partitioning condition generation apparatus related to the present disclosure.

FIG. 2 is a diagram illustrating an example of a field policy related to the present disclosure.

FIG. 3 is a diagram illustrating an example of limiting conditions related to the present disclosure.

FIG. 4 is a diagram illustrating examples of data to be partitioned and a configuration of fields making up respective data related to the present disclosure.

FIG. 5 is a diagram illustrating an example of a search condition related to the present disclosure.

FIG. 6 is a diagram illustrating an example of an operation of a data partitioning condition generation apparatus related to the present disclosure.

FIG. 7 is a diagram illustrating an example of an operation for partitioning data of a data partitioning condition generation apparatus related to the present disclosure.

FIG. 8 is a diagram illustrating an example of an operation for generating a search condition of a data partitioning condition generation apparatus 10 related to the present disclosure.

FIG. 9 is a diagram illustrating an example of a concrete example of an operation for partitioning data of a data partitioning condition generation apparatus related to the present disclosure.

FIG. 10 is a diagram illustrating an example of a concrete example of an operation for partitioning data of a data partitioning condition generation apparatus related to the present disclosure.

FIG. 11 is a diagram illustrating an example of a concrete example of an operation for partitioning data of a data partitioning condition generation apparatus related to the present disclosure.

FIG. 12 is a diagram illustrating an example of a concrete example of an operation for partitioning data of a data partitioning condition generation apparatus related to the present disclosure.

FIG. 13 is a diagram illustrating an example of a concrete example of an output of a partitioning condition of a data partitioning condition generation apparatus related to the present disclosure.

FIG. 14 is a block diagram illustrating an example of a configuration of a data partitioning system related to the present disclosure.

FIG. 15 is a diagram illustrating an example of an operation of a data partitioning system related to the present disclosure.

FIG. 16 is a diagram illustrating an example of a concrete example of an operation of a data partitioning system related to the present disclosure.

FIG. 17 is a diagram illustrating a configuration of a computer making up a data partitioning condition generation apparatus and a data partitioning system related to the present disclosure.

### EXAMPLE EMBODIMENTS

Note, in the present disclosure, drawings can be associated with one or more example embodiments. Furthermore, each example embodiment described below can appropriately be combined with other example embodiments and the present invention is not limited to each example embodiment.

First, an outline of an example embodiment will be described with reference to drawings. Note, in the following outline, reference signs of the drawings are denoted to each element as an example for the sake of convenience to facilitate understanding and are not intended to limit the present invention thereto. Furthermore, an individual connection line between blocks in the drawings, etc., referred to in the following description includes both one-way and two-way directions. A one-way arrow schematically illustrates a principal signal (data) flow and does not exclude bidirectionality.

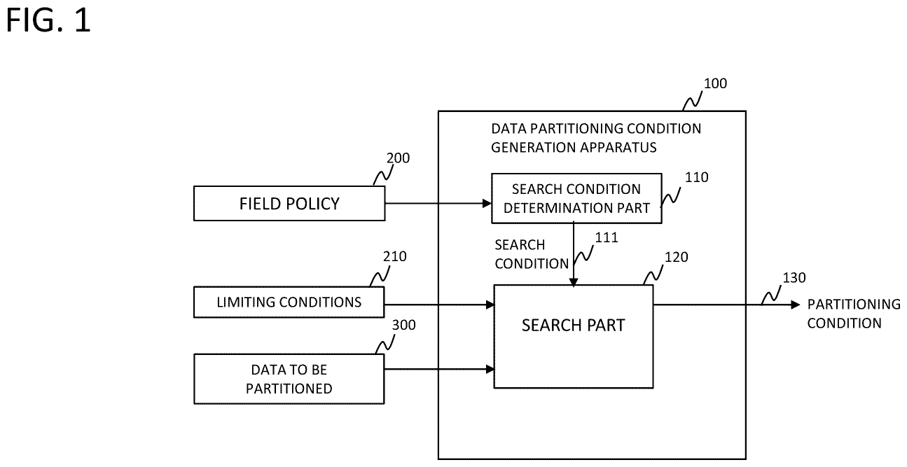

FIG. 1 is a block diagram illustrating an example of a configuration of a data partitioning condition generation apparatus related to the present disclosure. A data partitioning condition generation apparatus 100 includes a search condition determination part 110 and a search part 120. The search condition determination part 110 determines a search condition 111 based on a field policy 200. The search part 120 partitions data to be partitioned 300 based on the search condition 111 and outputs the search condition 111 as a partitioning condition 130 if it is determined that a result of the partitioning satisfies limiting conditions 210.

According to the example embodiment, it is possible to provide a data partitioning condition generation apparatus, a data partitioning system, a data partitioning condition generation method, and a program which contribute to enable to automatically determine lengths of respective fields which make up data whose format is unknown.

### First Example Embodiment

Next, a first example embodiment will be described with reference to drawings in detail. FIG. 1 is a block diagram illustrating an example of a configuration of a data partitioning condition generation apparatus 100 related to the present disclosure. The first example embodiment will be described with FIG. 1.

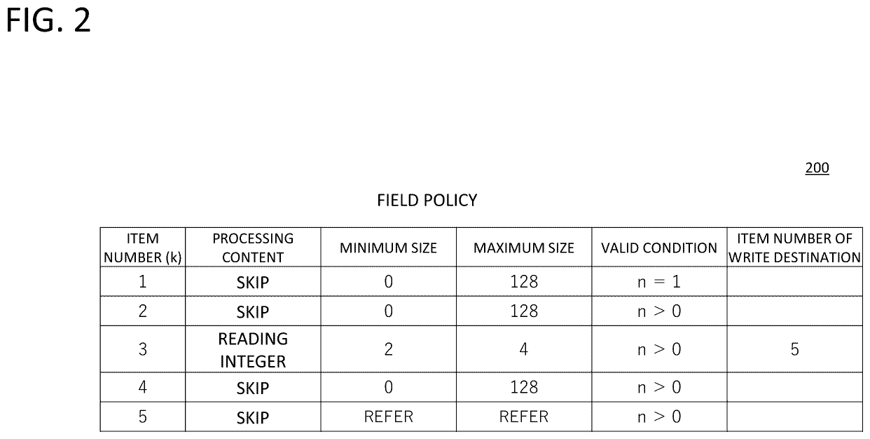

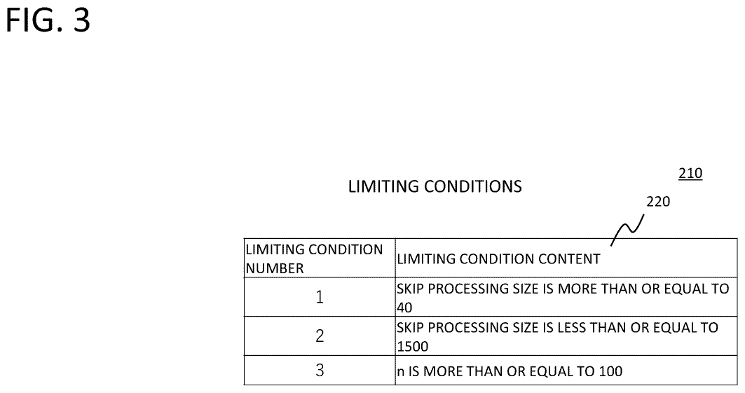

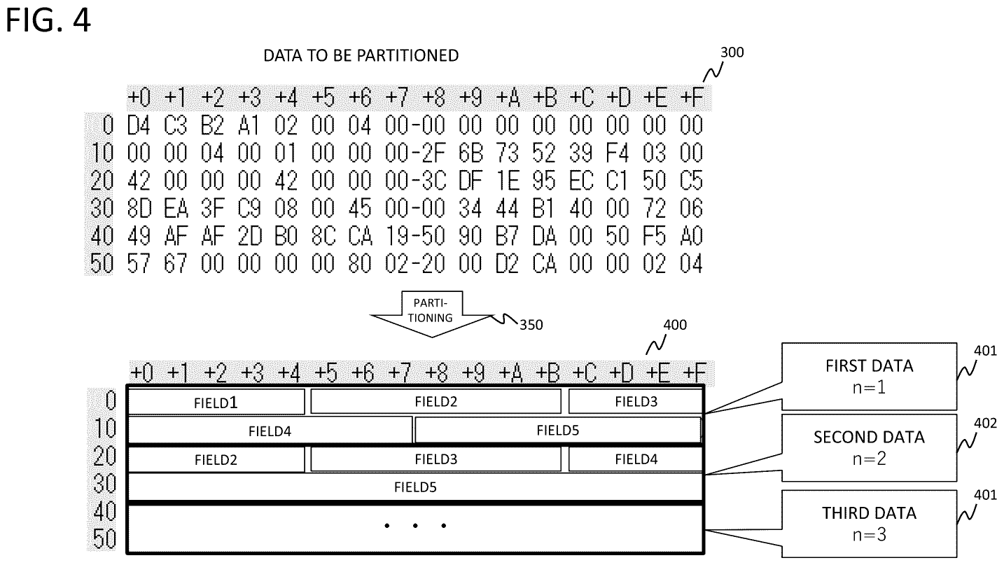

FIG. 2 is a diagram illustrating an example of a field policy 200 related to the present disclosure. The field policy 200 defines a framework of a partitioning method. FIG. 3 is a diagram illustrating an example of limiting conditions 210 related to the present disclosure. Limiting condition contents 220 in limiting conditions 210 define a maximum size of a variable skip processing (limiting condition number 2), a minimum size of a variable skip processing (limiting condition number 1), and limitation of a number of partitioning (limiting condition number 3). Note, it is assumed that n indicates a data number, that is a number of partitioning. FIG. 4 is a diagram illustrating examples of data to be partitioned 300 and a configuration of fields making up respective data related to the present disclosure. In FIG. 4, an example in which a first data is made up by fields 1 to 5, a second data is made up by fields 2 to 5, a third data is made up by fields 2 to 5 is shown. It is assumed that n described in FIG. 4 shows a data number as described above.

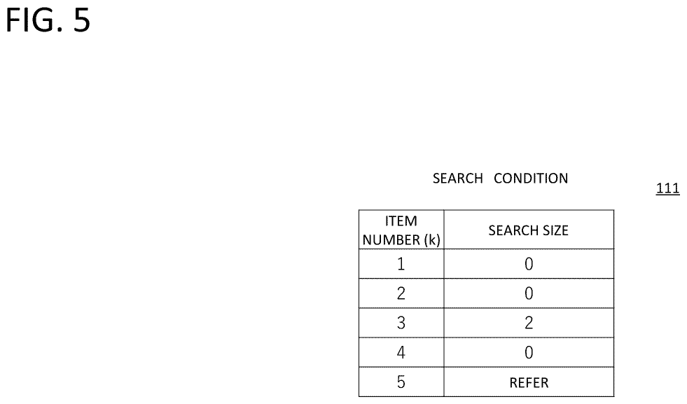

An item number (k) of a field policy 200 of FIG. 2 corresponds to a field number of each data as shown in FIG. 4. FIG. 5 is a diagram illustrating an example of a search condition 111 related to the present disclosure. An item number (k) of a search condition 111 corresponds to an item number (k) of a field policy 200 as shown in FIG. 2 and a field number of each data as shown in FIG. 4.

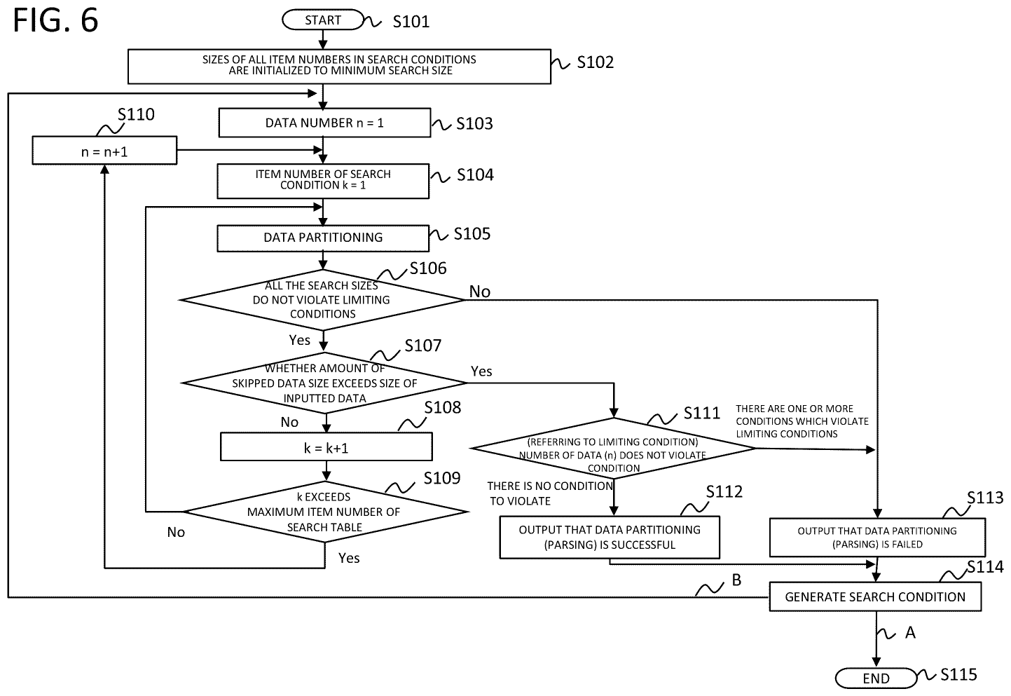

FIG. 6 is a diagram illustrating an example of an operation of a data partitioning condition generation apparatus 100 related to the present disclosure. A processing starts at step S101. At step S102, search sizes of all item numbers in search conditions are initialized to a minimum search size. At step S103, a data number is set to be n=1. At step S104, an item number of a search condition 111 is set to be k=1. At step S105, data partitioning is performed.

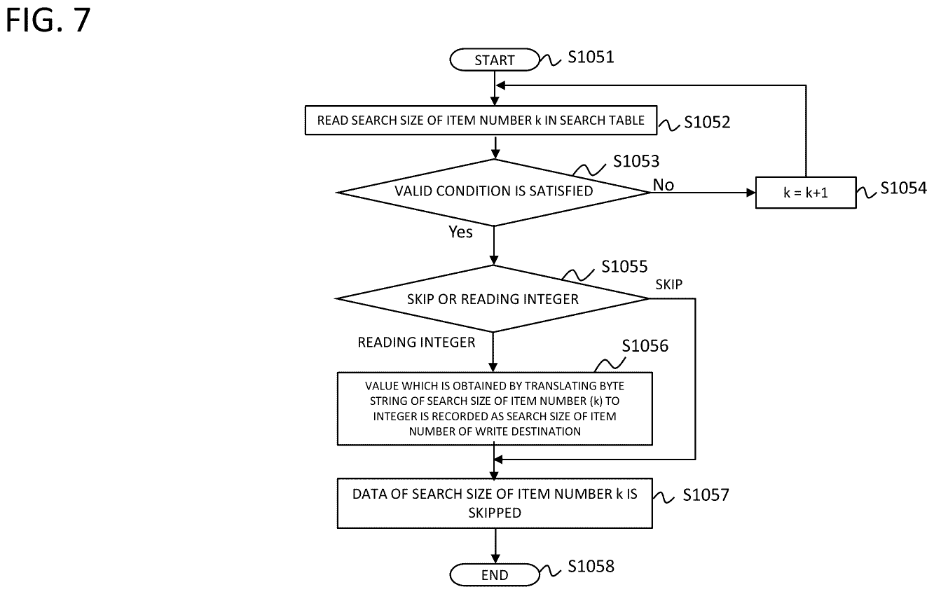

FIG. 7 is a diagram illustrating an example of an operation for partitioning data of a data partitioning condition generation apparatus 100 related to the present disclosure. FIG. 7 shows content of a data partitioning operation at step S105 as shown in FIG. 6.

Data partitioning starts at step S1051. Next, at step S1052, a search size of an item number k in the search condition 111 is read. At step S1053, if a data number n does not satisfy a valid condition (a valid condition of a field policy as shown in FIG. 2), a processing proceeds to step S1054. Then, k=k+1 is set and a processing returns to step S1052. If a valid condition is satisfied, a processing proceeds to step S1055. For example, when n=1 is set at step S103, a valid condition is satisfied in a case of partitioning a first data (n=1) and a processing proceeds to step S1055. In a case of partitioning a second data, a valid condition is not satisfied, and a processing proceeds to step S1054. That is, a processing for an item number 1 in a field policy 200 is not performed in a case of partitioning a second data (n=2).

In a case where a processing content of a field policy 200 is reading an integer at step S1055, a processing proceeds to step S1056. At step S1056, a value which is obtained by translating a byte string of a search size of an item number k in a search condition 111 to an integer is recorded as a search size of an item number of a write destination. Next, a process proceeds to step S1057. In a case where a processing content is a skip at step S1055, a processing proceeds to step S1057. At step S1057, the data to be partitioned 300 of a search size of an item number k in a search condition 111 is skipped. The data partitioning ends at step S1058, then a processing proceeds to step S106 of FIG. 6.

At step S106, it is checked that all the search sizes do not violate limiting conditions 210. If it is not satisfied (S106 No), a process proceeds to step S113 and an indication which shows that data partitioning (parsing) has been failed is outputted, then a process proceeds to step S114.

If it is satisfied (S106 Yes), a process proceeds to step S107. At step S107, it is checked whether an amount size of skipped data exceeds a size of inputted data. If it exceeds (S107 Yes), a process proceeds to step S111. At step S111, with reference to limiting condition contents 220 of a limiting condition number 3 in limiting conditions 210, if a number of data (n) does not violate the condition, a process proceeds to step S112. Then, a partitioning condition 130 is outputted along with an indication which shows that data partitioning (parsing) is successful. Then, a process proceeds to step S114.

At step S107, in a case where an amount size of skipped data does not exceed a size of inputted data (S107 No), a processing proceeds to step S108. At step S108, k=k+1 is set, and a processing proceeds to step S109. At step S109, it is checked whether k exceeds a maximum item number of an item (k) of search conditions 111. If it does not exceed (step S109 No), a processing returns to step S105. If it exceeds a maximum item number (step S109 Yes), a processing proceeds to step S110. At step S110, n=n+1 is set, and a processing proceeds to step S104

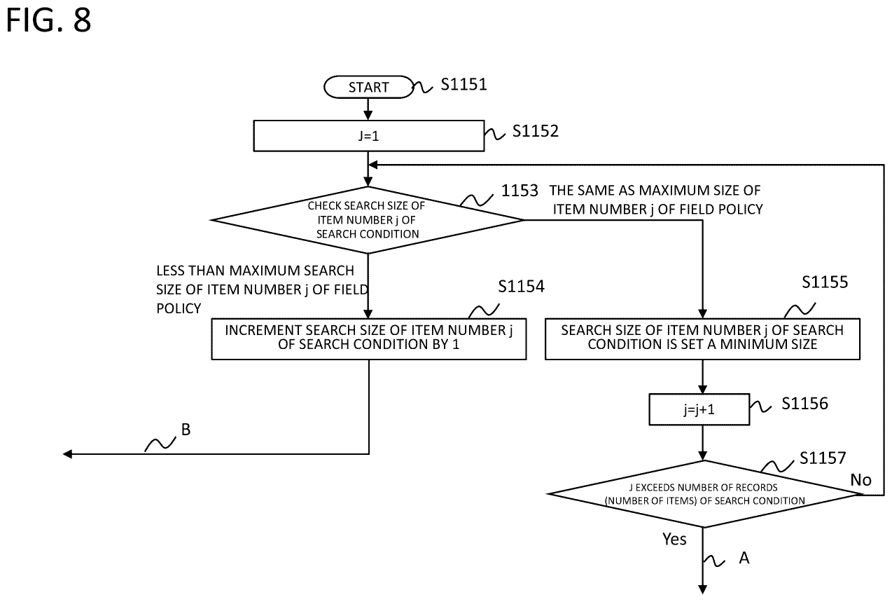

At step S114, a search condition is generated. FIG. 8 is a diagram illustrating an example of an operation for generating a search condition of a data partitioning condition generation apparatus 100 related to the present disclosure. FIG. 8 illustrates a content of an operation for generating a search condition at step S114 as shown in FIG. 6.

A processing of generating a search condition starts at step S1151. Next, at step S1152, j=1 is set. Next, at step S1153, a search size of an item number j of a search condition is checked. If it is the same as a maximum size of an item number j of a field policy 200, a processing proceeds to step S1155. At step S 1155, a search size of an item number j of a search condition is set a minimum size. Next, at step S1156, j=j+1 is set and a processing proceeds to step S1157. At step S1157, it is checked whether j exceeds a number of records (a number of items) of a search condition and if it does not exceed (S1157 No), a processing returns to step S1153. If it exceeds (S1157 Yes), a processing proceeds to A as shown in FIG. 6 and a processing ends at step S115.

At step S1153, in a case where a search size is less than a maximum size of an item number j of a field policy 200, a processing proceeds to step S1154. At step S1154, a search size of an item number j of a search condition is incremented by one (1) and a processing proceeds along B in FIG. 6 to return to step S103.

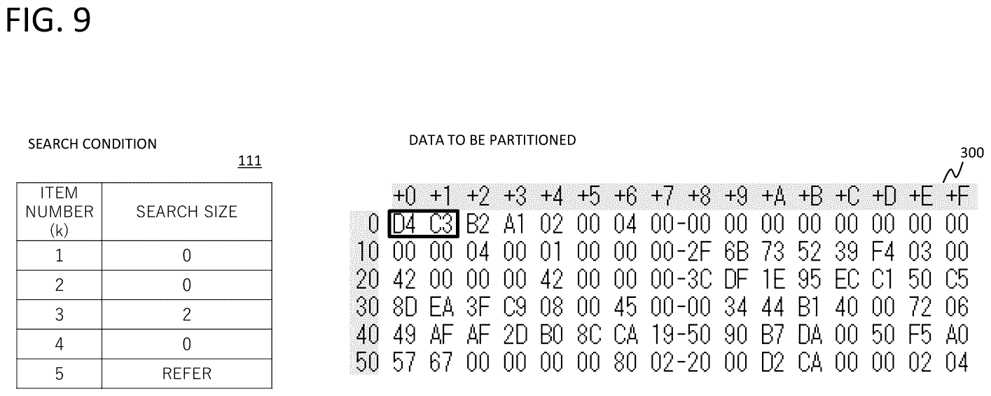

Next, an example of a concrete example of an operation for partitioning data of a data partitioning condition generation apparatus will be described. FIGS. 9 to 12 are diagrams illustrating examples of concrete examples of operations for partitioning data of a data partitioning condition generation apparatus related to the present disclosure.

FIG. 9 illustrates a processing in a case where a first data (n=1) is partitioned. When a partitioning operation is performed according to a search condition 111, data to be partitioned 300 is read according to a search size “2” of an item number 3 because search sizes of item numbers 1 and 2 are zeros (0's). The item number 3 corresponds to an item number 3 of a field policy 200 and a processing content is “reading an integer”. Therefore, a value C3D4 (a hexadecimal number) (50132 (a decimal number)) is read and this value indicates a size of an item number 5 of a write destination. Because this size violates a limiting condition content 220 of a limiting condition number 2 in limiting conditions 210, a search condition 111 as shown in FIG. 9 is not suitable as a partitioning condition.

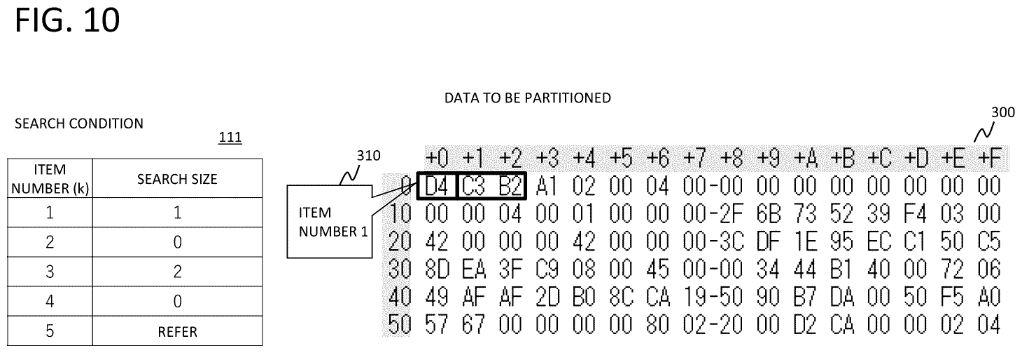

FIG. 10 illustrates a case where a next search condition 111 is generated at step S114 of FIG. 6. A size of an item number 1 is “1 (one)”. Because the item number 1 is a field indicating a value D4 and a size of an item 2 is zero, data to be partitioned is read according to a search size “2” of an item number 3. Because an item number 3 corresponds to an item number 3 of a field policy 200 which shows that a processing content is “reading an integer”, a value B2C3 (a hexadecimal number) (45763 (a decimal number)) is read and this value indicates a size of an item number 5 of a write destination. Because this size violates a limiting condition content 220 of a limiting condition number 2 in limiting conditions 210, a search condition is not suitable as a partitioning condition.

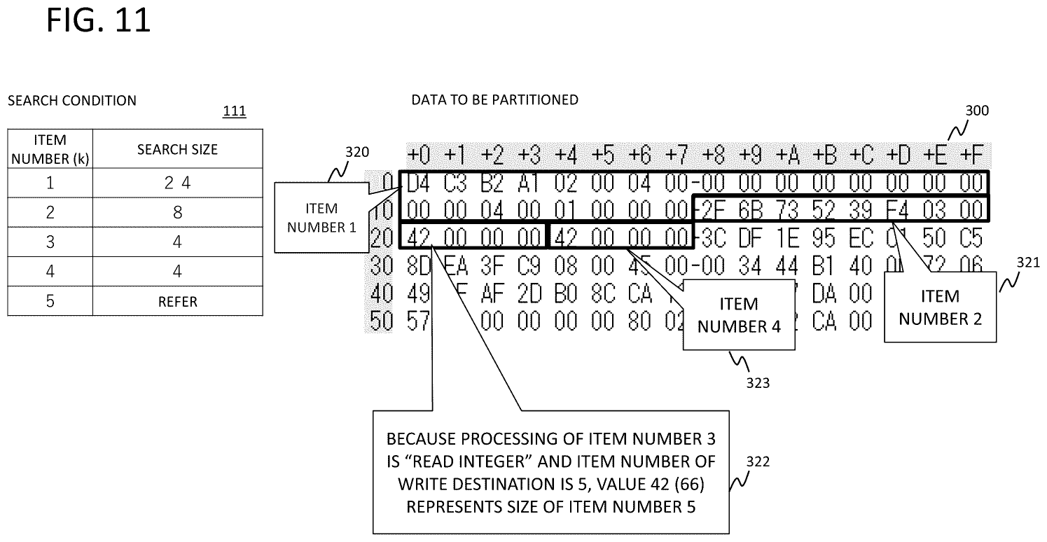

FIG. 11 shows a case where a different search condition 111 is generated at step S114 as shown in FIG. 6 thereafter. A search size for an item number 1 is 24, a search size for an item number 2 is 8, a search size for an item number 3 is 4, and a search size for an item number 4 is 4. In FIG. 11, because a processing of an item number 3 of a fields policy 200 is “reading an integer” and an item number of a write destination of an item number 3 of a field policy 200 is 5, a value 42 (a hexadecimal number) (66 (a decimal number)) indicates a size of item number 5. Because this does not violate limiting conditions 210, the next part of data will be partitioned.

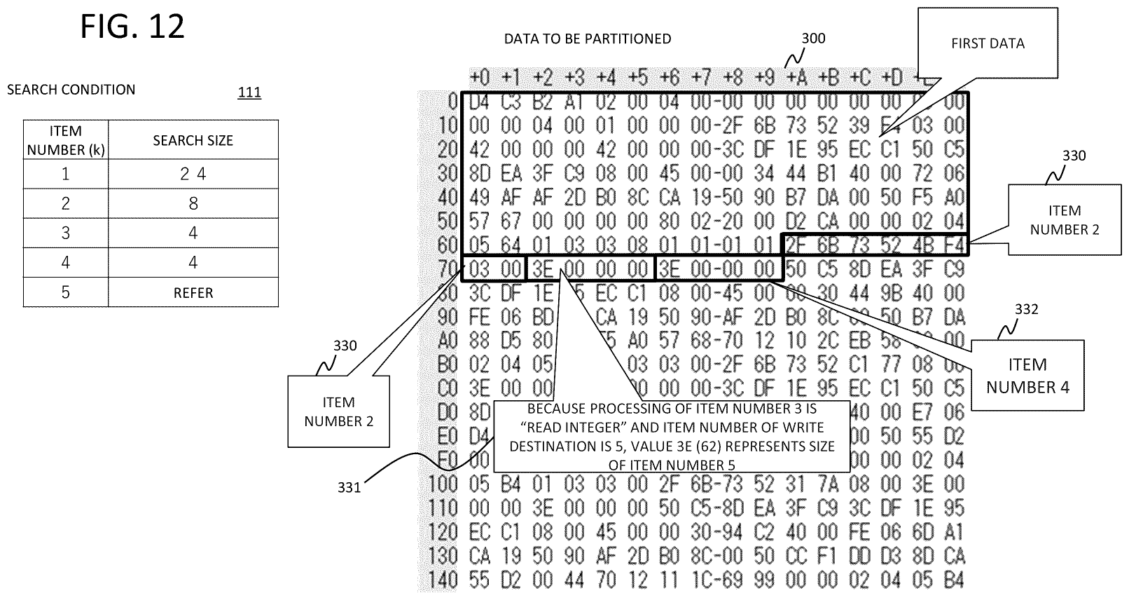

FIG. 12 illustrates a processing for a second data (n=2). According to a search condition 111 as shown in FIG. 12, a search size for an item number 2 is 8, a search size for an item number 3 is 4, and a search size for an item number 4 is 4. As shown on data to be partitioned 300 of FIG. 12, item numbers 2, 3, and 4 of a second data follow the first data. Because a processing of an item number 3 of a field policy 200 is “reading an integer” and its item number of a write destination is 5, a value 3E (62) indicates a size of item number 5. Because this does not violate limiting conditions 210, the next part of data will be partitioned.

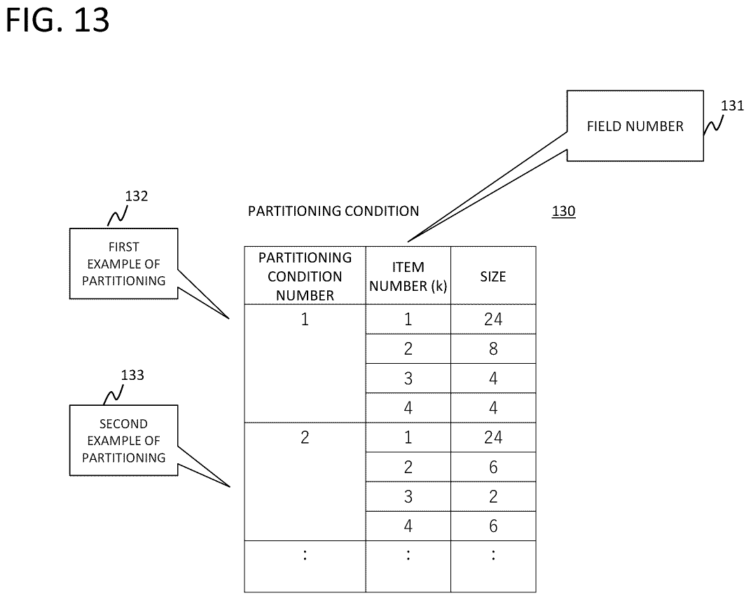

FIG. 13 illustrates an output of a partitioning condition 130 in a case where data to be partitioned 300 is partitioned by operations as described above. Operations as shown in FIG. 6 are performed for all combinations of search sizes, and partitioning conditions 130 which do not violate limiting conditions 210 are acquired as an output. As an example, FIG. 13 describes two examples of partitioning. That is, in a first example of partitioning, it is shown that data to be partitioned can be partitioned under limiting condition 210 in such way that a size of a field 1 is 24, a size of a field 2 is 8, a size of field 3 is 4, a size of field 4 is 4, and a size of field 5 is a size determined by an integer value of a field 3.

As described above, according to the first example embodiment, it is possible to provide a data partitioning condition generation apparatus, a data partitioning condition generation method, and a program which contribute to enable to automatically determine lengths of respective fields which make up data whose format is unknown.

### Second Example Embodiment

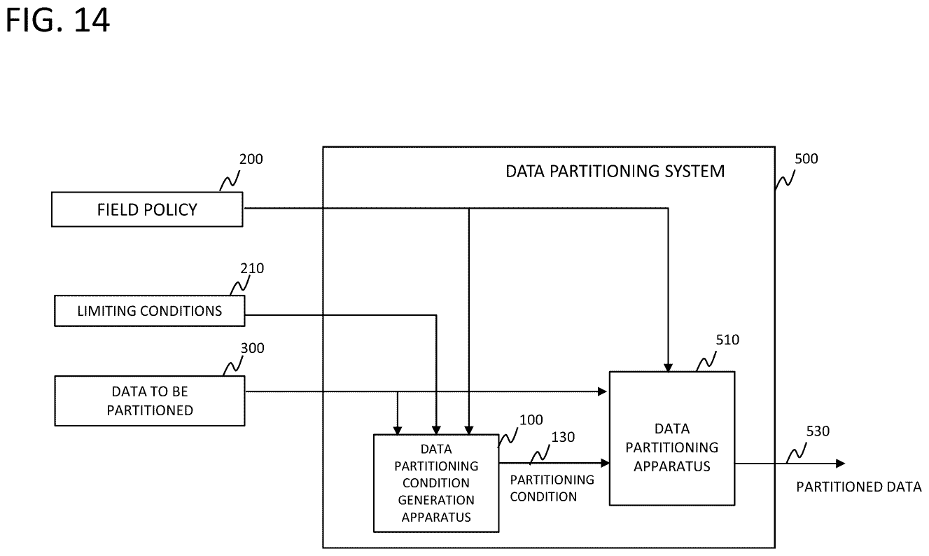

Next, a second example embodiment will be described with reference to drawings in detail. FIG. 14 is a block diagram illustrating an example of a configuration of a data partitioning system related to the present disclosure. In FIG. 14, components denoted by the same reference numerals as those in FIG. 1 indicate the same components.

A data partitioning system 500 includes a data partitioning condition generation apparatus 100 and a data partitioning apparatus 510. A data partitioning condition generation apparatus 100 may be the same one as a data partitioning condition generation apparatus 100 shown in FIG. 1.

The data partitioning condition generation apparatus 100 includes a search condition determination part 110 and a search part 120. The search condition determination part 110 determines a search condition 111 based on a field policy 200. The search part 120 partitions data to be partitioned 300 based on the search condition 111 and outputs the search condition 111 as a partitioning condition 130 if it is determined that a result of the partitioning satisfies limiting conditions 210.

The data partitioning apparatus 510 determines a number of the data to be partitioned which is to be read based on the partitioning condition 130 according to the field policy 200, reads the determined number of the data to be partitioned and outputs the partitioned data 530.

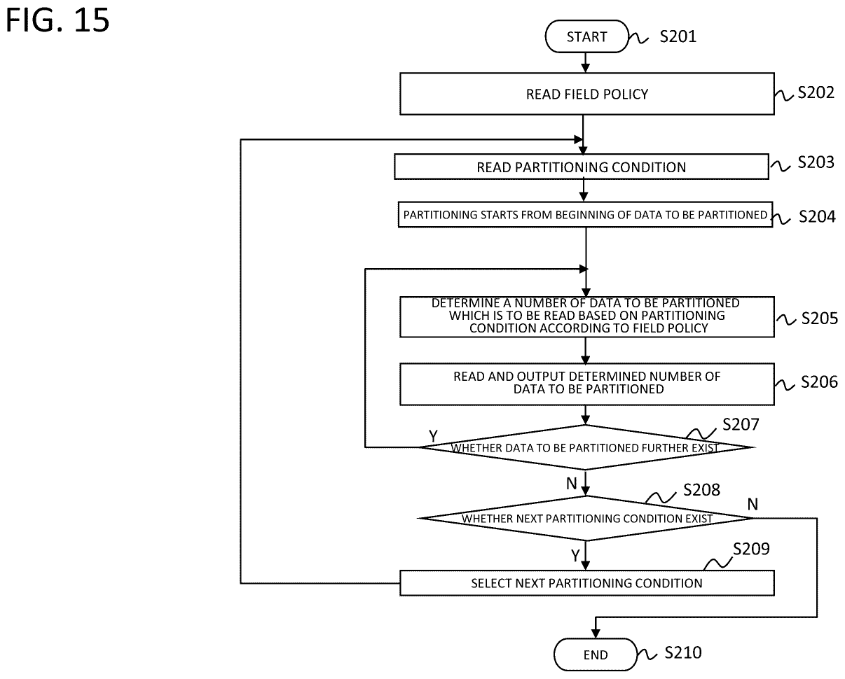

FIG. 15 is a diagram illustrating an example of an operation of a data partitioning system 500 related to the present disclosure. A processing starts at step S201. Next, at step S202, a field policy 200 is read. Next, at step S203, a partitioning condition 130 is read. Next, at step S204, partitioning starts from the beginning of data to be partitioned 300.

At step S205, a number of the data to be partitioned which is to be read is determined based on the partitioning condition 130 according to the field policy 200. Next, at step S206, the determined number of the data to be partitioned is read and outputted. Next, at step S207, it is checked whether data to be partitioned further exists. If data to be partitioned further exists (step S207 Y), a processing returns to step S205. If it does not exist (step S207 N), partitioning according to one partitioning condition is finished and a processing proceeds to step S208. At step S208, it is checked whether a next partitioning condition exists. If the next partitioning condition exists (S208 Y), a processing proceeds to step S209 to select the next partitioning condition and a processing proceeds to step S203. If the next partitioning condition does not exist (S208 N), a processing proceeds to step S210 and ends.

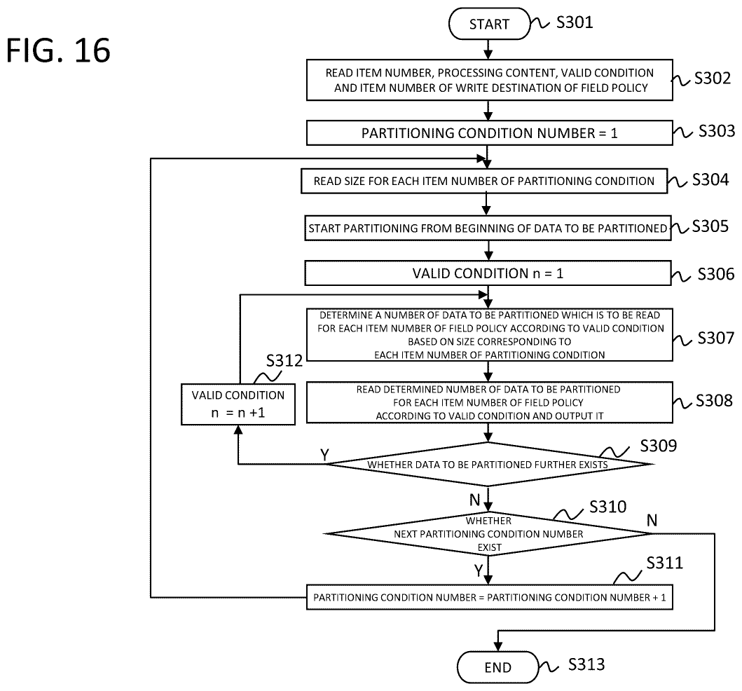

FIG. 16 is a diagram illustrating an example of a concrete example of an operation of a data partitioning system related to the present disclosure. FIG. 16 is a diagram illustrating an example of a concrete example of an operation of a data partitioning system in a case where a field policy 200 as shown in FIG. 2 and a partitioning condition 130 as shown in FIG. 13 are used.

A processing starts at step S301. Next, at step S302, item numbers, processing contents, valid conditions and an item number of write destination of a field policy 200 are read. Next, at step S303, a partitioning condition number=1 is set. Next, at step S304, a size for each item number of a partitioning condition is read. Next, at step S305, partitioning starts from the beginning of data to be partitioned.

At step S306, a valid condition n=1 is set. Next, at step S307, a number of data to be partitioned which is to be read is determined for each item number of a field policy 200 according to a valid condition based on a size corresponding to each item number of a partitioning condition 130. Next, at step S308, the determined number of the data to be partitioned is read for each item number of a field policy 200 according to a valid condition in order and output it. Next, at step S309, it is checked whether data to be partitioned further exists. If data to be partitioned further exists (step S309 Y), a processing proceeds to step S312 and a valid condition n=n+1 is set. Then, a processing returns to step S307.

At step S309, any data to be portioned does not exist (S309 N), a processing proceeds to step S310. At step S310, it is checked whether a next partitioning condition number exists. If it exists (S310 Y), a processing proceeds step S311. At step S311, a partitioning condition number=a partitioning condition number+1 is set and a processing returns step S304.

On the other hand, at step S310, if a next partitioning condition number does not exist (S310 N), a processing proceeds to step S313 and a processing ends.

As described above, according to the second example embodiment, it is possible to provide a data partitioning system, a data partitioning method, and a program which contribute to enable to automatically determine lengths of respective fields which make up data whose format is unknown and partition the data whose format is unknown.

While example embodiments of the present invention have thus been described, the present invention is not limited thereto. Further modifications, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings. In addition, “A and/or B” signifies at least one of A or B.

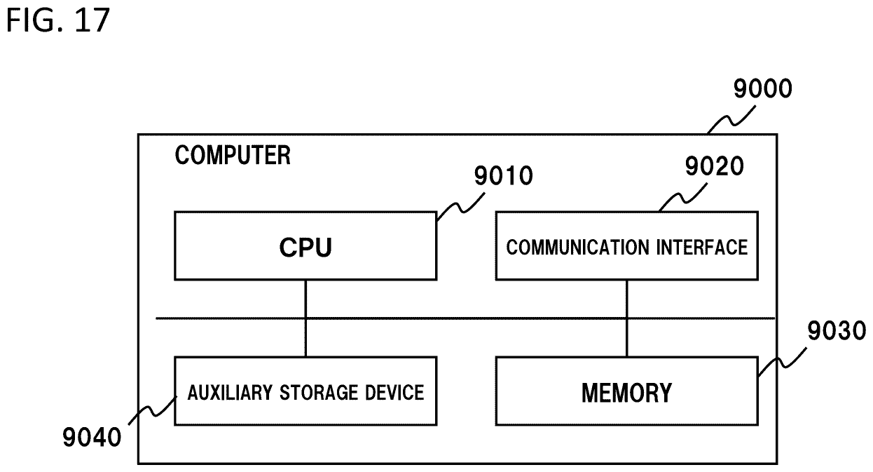

In addition, the procedure according to the above-described first to second example embodiments can be realized by a program that causes a computer (9000 in FIG. 17) functioning as the data partitioning condition generation apparatus or the data partitioning system according to the present invention to realize the functions of the data partitioning condition generation apparatus or the data partitioning system. This computer has a configuration illustrated as an example in FIG. 17 which includes a central processing unit (CPU) 9010, a communication interface 9020, a memory 9030, and an auxiliary storage device 9040. That is, the CPU 9010 in FIG. 17 executes a control program of the data partitioning condition generation apparatus or the data partitioning system, and executes a processing for updating individual calculation parameters stored in the auxiliary storage device 9040 or the like.

The memory 9030 is a random access memory (RAM), a read-only memory (ROM), or the like.

That is, the individual unit (processing means or function) of the data partitioning condition generation apparatus or the data partitioning system according to the above-described first to second example embodiments can be realized by a computer program that causes a processor of the above-described computer to use corresponding hardware and to execute the corresponding processing described above.

Finally, suitable modes of the present invention will be summarized.

### Mode 1

A data partitioning condition generation apparatus may comprise a search condition determination part and a search part.

The search condition determination part may determine a search condition based on a field policy.

The search part may partition data to be partitioned based on the search condition.

The search part may output the search condition as a partitioning condition if it is determined that a result of the partitioning satisfies limiting conditions.

### Mode 2

A data partitioning system may comprise a data partitioning condition generation apparatus and a data partitioning apparatus.

The data partitioning condition generation apparatus may comprise a search condition determination part and a search part.

The search condition determination part may determine a search condition based on a field policy.

The search part may partition data to be partitioned based on the search condition.

The search part may output the search condition as a partitioning condition if it is determined that a result of the partitioning satisfies limiting conditions.

The data partitioning apparatus may determine a number of the data to be partitioned which is to be read based on the partitioning condition according to the field policy, read the determined number of the data to be partitioned, and output the partitioned data.

### Mode 3

In the data partitioning condition generation apparatus according to mode 1, it is preferable that the field policy indicates a processing content, and the processing content is a skip or reading an integer.

### Mode 4

In the data partitioning condition generation apparatus according to mode 3, it is preferable that the field policy comprises an item number of a write destination in a case where the processing content is reading an integer.

### Mode 5

In a data partitioning condition generation method, a computer may determine a search condition based on a field policy.

The computer may partition data to be partitioned based on the search condition.

The computer may output the search condition as a partitioning condition if it is determined that a result of the partitioning satisfies limiting conditions.

### Mode 6

In a data partitioning method, a computer may determine a search condition based on a field policy.

The computer may partition data to be partitioned based on the search condition.

The computer may output the search condition as a partitioning condition if it is determined that a result of the partitioning satisfies limiting conditions.

The computer may determine a number of the data to be partitioned which is to be read based on the partitioning condition according to the field policy, read the determined number of the data to be partitioned, and output the partitioned data.

### Mode 7

In the data partitioning condition generation method according to mode 5, it is preferable that the field policy indicates a processing content, and the processing content is a skip or reading an integer.

### Mode 8

A program may cause a computer to perform processing of determining a search condition based on a field policy.

The program may cause a computer to perform processings of partitioning data to be partitioned based on the search condition, and outputting the search condition as a partitioning condition if it is determined that a result of the partitioning satisfies limiting conditions.

### Mode 9

A program may cause a computer to perform processing of determining a search condition based on a field policy.

The program may cause a computer to perform processing of partitioning data to be partitioned based on the search condition.

The program may cause a computer to perform processing of outputting the search condition as a partitioning condition if it is determined that a result of the partitioning satisfies limiting conditions.

The program may cause a computer to perform processings of determining a number of the data to be partitioned which is to be read based on the partitioning condition according to the field policy, reading the determined number of the data to be partitioned, and outputting the partitioned data.

### Mode 10

The program according to mode 8 or 9, it is preferable that the field policy indicates a processing content, and the processing content is a skip or reading an integer.

Modes 7 and 10 described above can be expanded in the same way as mode 1 is expanded to mode 4.

### Mode 11

(5) A data partitioning condition generation method, wherein a computer
determines a search condition based on a field policy,
partitions data to be partitioned based on the search condition, and
outputs the search condition as a partitioning condition if it is determined that a result of the partitioning satisfies limiting conditions.

### Mode 12

(6) A data partitioning method, wherein
a computer
determines a search condition based on a field policy,
partitions data to be partitioned based on the search condition,
outputs the search condition as a partitioning condition if it is determined that a result of the partitioning satisfies limiting conditions,
determines a number of the data to be partitioned which is to be read based on the partitioning condition according to the field policy,
reads the determined number of the data to be partitioned, and outputs the partitioned data.

### Mode 13

(7) The data partitioning condition generation method according to (5),
wherein the field policy indicates a processing content, and
wherein the processing content is a skip or reading an integer.

### Mode 14

(9) A program causing a computer to perform processings of:
determining a search condition based on a field policy,
partitioning data to be partitioned based on the search condition,
outputting the search condition as a partitioning condition if it is determined that a result of the partitioning satisfies limiting conditions,
determining a number of the data to be partitioned which is to be read based on the partitioning condition according to the field policy,
reading the determined number of the data to be partitioned, and
outputting the partitioned data.

The disclosure of the above PTL is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

100 data partitioning condition generation apparatus
110 search condition determination part
111 search condition
120 search part
130 partitioning condition
200 field policy
210 limiting conditions
220 limiting condition content
300 data to be partitioned
500 data partitioning system
510 data partitioning apparatus
530 partitioned data
9000 computer
9010 CPU
9020 communication interface
9030 memory
9040 auxiliary storage device

What is claimed is:

1. A data partitioning condition generation apparatus, comprising:
a memory in circuit communication with a processor,
wherein the processor is configured to execute program instructions stored in the memory to perform:
determining a search condition based on a field policy,
partitioning data to be partitioned based on the search condition, and
outputting the search condition as a partitioning condition if it is determined that a result of the partitioning satisfies limiting conditions.

2. A data partitioning system, comprising:
a memory in circuit communication with the processor,
wherein the processor is configured to execute program instructions stored in the memory to perform:
determining a search condition based on a field policy,
partitioning data to be partitioned based on the search condition,
outputting the search condition as a partitioning condition if it is determined that a result of the partitioning satisfies limiting conditions,
determining a number of the data to be partitioned which is to be read based on the partitioning condition according to the field policy,
reading the determined number of the data to be partitioned, and outputting the partitioned data.

3. The data partitioning condition generation apparatus according to claim 1,
wherein the field policy indicates a processing content, and
wherein the processing content is a skip or reading an integer.

4. The data partitioning condition generation apparatus according to claim 3,
wherein the field policy comprises an item number of a write destination in a case where the processing content is reading an integer.

5. A computer-readable non-transitory recording medium recording a program, the program causing a computer to perform processings of:
determining a search condition based on a field policy,
partitioning data to be partitioned based on the search condition, and
outputting the search condition as a partitioning condition if it is determined that a result of the partitioning satisfies limiting conditions.

6. The medium according to claim 5,
wherein the field policy indicates a processing content, and
wherein the processing content is a skip or reading an integer.

7. The medium according to claim 6,
wherein the field policy comprises an item number of a write destination in a case where the processing content is reading an integer.
